(19) United States
(12) Patent Application Publication
(10) Pub. No.: US 2017/0067368 A1
(43) Pub. Date: Mar. 9, 2017

(54) STEAM TURBINE INNER CASING WITH MODULAR INSERTS

(71) Applicant: General Electric Technology GmbH, Baden (CH)

(72) Inventors: ALAIN DENIS MALAGUTI LARRAZABAL, Bulach (CH); SILVIA GAFNER, Teufentha (CH); THOMAS SCHREIER, Neuenhof (CH); MIRKO RUEDI MEIER, Aarau (CH); ANDRZEJ KONIECZNY, Ennetbaden (CH)

(21) Appl. No.: 15/257,136

(22) Filed: Sep. 6, 2016

(30) Foreign Application Priority Data
Sep. 8, 2015 (CN) 201520688951.2

(51) Int. Cl. F01D 25/26

(52) U.S. Cl. CPC F01D 25/265; F05D 2220/31; F05D 2260/30

(57) ABSTRACT

The embodiments relate to a steam turbine with modular inserts that are removably insertable into an inner case. The modular inserts include a seal carrier modular insert located towards a first end of the steam turbine, for carrier seals located between the inner casing the rotor, that is cylindrically shaped and removably insertable into the inner casing, an inlet spiral insert, adjacent the seal carrier modular insert and removably insertable into the inner casing, for introducing steam into the steam expansion flow path so as to circumferentially distribute steam feed into the steam turbine; and a blade carrier modular insert, adjacent the inlet spiral insert, that is also cylindrically shaped and removably insertable into the inner casing, for retaining stationary blades.

### TECHNICAL FIELD

The present disclosure relates generally to steam turbines and more specifically to steam turbine inner casing arrangements.

### BACKGROUND

Casing distortion is a known problem of steam turbines that increases with increasing operating cycles. The most common causes of distortion are steady state and transient thermal stresses. In particular, inner casings may distort more easily than outer casings due to their thinner cross-section and higher casing wall temperature differentials. These distortions may not only lead to disassembly and reassembly problems but also steam leakage and rubbing that results in reduced efficiency and power output.

Another problem is cracking at steam inlet areas as a result of transient thermal stresses exceeding the yield point of the casing material. Resulting cracking may be located on the interior surfaces of steam chests, valve bodies, nozzle chambers, seal casings, diaphragm fits and bolt holes. While computer modelling and the use of advanced alloys may reduce the likelihood of cracking, cracks can still develop in any unit, especially those experiencing a large number of stop/start cycles.

### BRIEF DESCRIPTION

A steam turbine arrangement is disclosed. The disclosure is intended to provide a solution to crack propagation occurring in the areas around a steam turbine inlet due to high temperature gradients, resulting in decreased turbine lifetime.

The disclosure is based on the general idea of providing a three piece modular insert that allows for a flexible inlet spiral of thin cross section. The implementation of the modular design allows for the thermal gradient to be decreased and the possibility to replace damaged internal components, thus increasing the lifetime of the steam turbine module.

In an aspect, a steam turbine arrangement includes an outer casing defining an outer limit of the steam turbine, and an inner casing enclosed by the outer casing. They are configured and arranged to form a steam expansion flow path in which work is generated by turbine stages located within the inner case and a rotor, concentric to and contained at least partially within both the inner casing and the outer casing. The steam turbine further includes a seal carrier modular insert, an inlet spiral insert, and a blade carrier modular insert. The seal carrier modular insert is located axially opposite to the steam expansion flow path of the steam turbine and is configured to carry seals located between the inner casing and the rotor. Furthermore, the seal carrier modular insert is cylindrically shaped and removably insertable into the inner casing. The inlet spiral insert is located adjacent the seal carrier modular insert and removably insertable into the inner casing and is further configured to introduce steam into the steam expansion flow path so as to circumferentially distribute steam into the steam turbine expansion flow path. The blade carrier modular insert is located adjacent the inlet spiral insert, is cylindrically shaped and removably insertable into the inner casing, and configured to retain stationary blades.

In an aspect, the inner casing and the seal carrier modular insert complementarily include a first slot and a first key configured to prevent rotation of the seal carrier module within the inner casing.

In an aspect, the inner casing and the inlet spiral insert complementarily include a second slot and a second key configured to prevent rotation of the inlet spiral insert within the inner casing.

In an aspect, the inner casing and the blade carrier modular insert complementarily include a third slot and a third key configured to prevent rotation of blade carrier modular insert within the inner casing.

In an aspect, the inner casing includes a circumferential first radial protrusion and the seal carrier modular insert includes a circumferential first groove that is configured to receive the first protrusion. The first radial protrusion and the first groove are complementarily configured such that radial pressure resulting from thermal expansion of the seal carrier modular insert is transferred to the inner casing thereby forming a seal between the inner casing and the seal carrier modular insert.

In an aspect, the inner casing includes a circumferential second radial protrusion and the blade carrier modular insert includes a circumferential second groove configured to receive the second protrusion. The second radial protrusion and the second groove are complementarily configured such that radial pressure resulting from thermal expansion of the blade carrier modular insert is transferred to the inner casing thereby forming a seal between the inner casing and the blade carrier modular insert.

In an aspect, the seal carrier modular insert includes two seal carrier halves split along a longitudinal axis of the seal carrier modular insert.

In a further aspect, the two seal carrier halves are joinable by bolted joints.

In an aspect, the blade carrier modular insert includes two blade carrier halves split along a longitudinal axis of the blade carrier modular insert.

In a further aspect, the two blade carrier halves are joinable by bolted joints.

In a general aspect, the steam turbine is configured as a high pressure steam turbine.

Other aspects and advantages of the present disclosure will become apparent from the following description, taken in connection with the accompanying drawings, which by way of example illustrate exemplary embodiments of the present invention.

### BRIEF DESCRIPTION OF THE DRAWINGS

By way of example, an embodiment of the present disclosure is described more fully hereinafter with reference to the accompanying drawings, in which:

FIG. 1 is a schematic of a steam turbine of the prior art to which exemplary embodiments may be applied;

FIG. 2 is a perspective view of modular inserts of an exemplary embodiment;

FIG. 3 is a cross section a steam turbine inner casing in which the modular inserts of FIG. 2 may be inserted;

FIG. 4 is a cross sectional view of the modular inserts of FIG. 2 inserted into the inner casing of FIG. 3; and

FIG. 5 is another perspective view of the modular inserts of FIG. 2.

### DETAILED DESCRIPTION

Exemplary embodiments of the present disclosure are now described with references to the drawings, wherein like reference numerals are used to refer to like elements throughout. In the following description, for purposes of explanation, numerous specific details are set forth to provide a thorough understanding of the disclosure. However, the present disclosure may be practiced without these specific details, and is not limited to the exemplary embodiments disclosed herein.

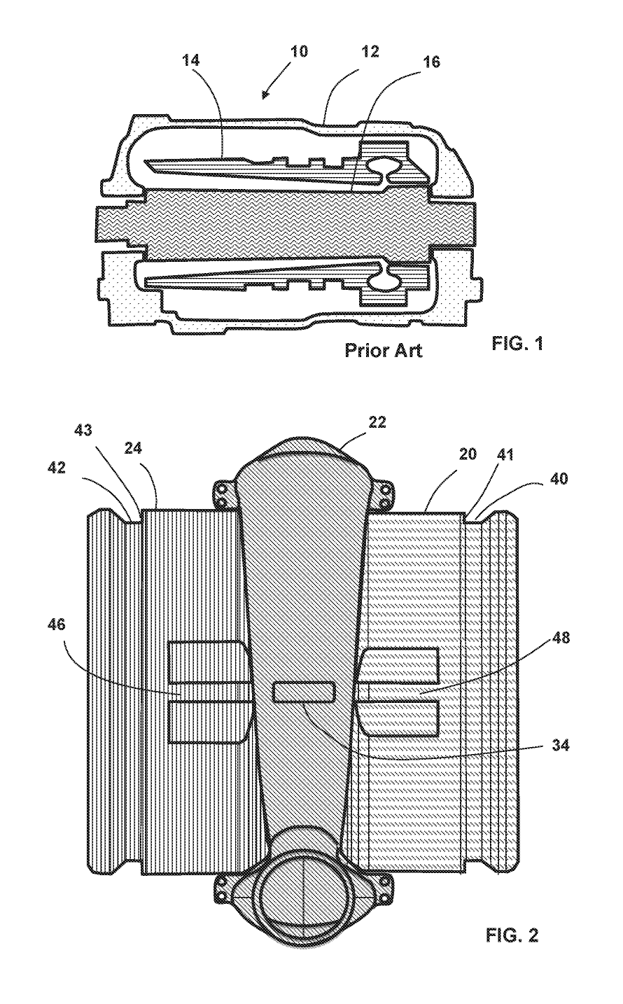

FIG. 1 shows an exemplary steam turbine 10 to which exemplary embodiments may be applied. The steam turbine 10 has an outer casing 12 that defines the outer limits of the steam turbine 10. The outer casing 12 surrounds and encases an inner case 14 that is configured and arranged to form a steam expansion flow path between the inner case 14 and a rotor 16 that is concentric to and at least partially contained within both the inner casing 14 and the outer casing 12.

FIG. 2 shows an exemplary longitudinally aligned series of modular inserts including a seal carrier modular insert 20, an inlet spiral insert 22, and a blade carrier modular insert 24.

The seal carrier modular insert 20, is typically located towards a first end of the steam turbine 10 upstream of the steam entry point of the steam turbine 10, and is configured to carry seals located between the inner casing 14 and the rotor 16. The seal carrier modular insert 20 is cylindrically shaped and removably insertable into the inner casing 14. As shown in FIG. 5, in an exemplary embodiment, the seal carrier modular insert 20 includes two seal carrier halves 20a, b that are joinable by bolts and may further be joined in compression by a protrusion 30a of the inner casing 14 that extends into a groove 40 of the seal carrier modular insert 20. By using a combination of bolts and compression, the modular insert design capitalizes on the different materials of the inner casing 14 and the seal carrier modular insert 20 to generate compressive forces against the seal carrier modular insert 20. In this way, the seal carrier modular insert 20 is held in place by the steam pressure and radial compression.

FIG. 2 further shows an inlet spiral insert 22 that may be removably fixed into the inner casing 14 and located adjacent the seal carrier modular insert 20. The purpose of the inlet spiral insert 22 is to introduce steam into the steam expansion flow path so as to circumferentially distribute steam into the steam turbine.

FIG. 2 further shows a blade carrier modular insert 24, located axially adjacent the inlet spiral insert 22, for retaining stationary blades. The blade carrier modular insert 24 is cylindrically shaped and removably insertable into the inner casing 14. As shown in FIG. 5, in an exemplary embodiment, the blade carrier modular insert 24 includes two blade carrier halves 24a, b that are joinable by bolts and may further be joined in compression by a protrusion 30b of the inner casing 14 that extends into a groove 42 of the blade carrier modular insert 24. By using a combination of bolts and compression, the modular insert design capitalizes on the different materials of the inner casing 14 and the blade carrier modular insert 24 to generate compressive forces against the blade carrier modular insert 24. In this way, the blade carrier modular insert 24 is held in place by the steam pressure and radial compression.

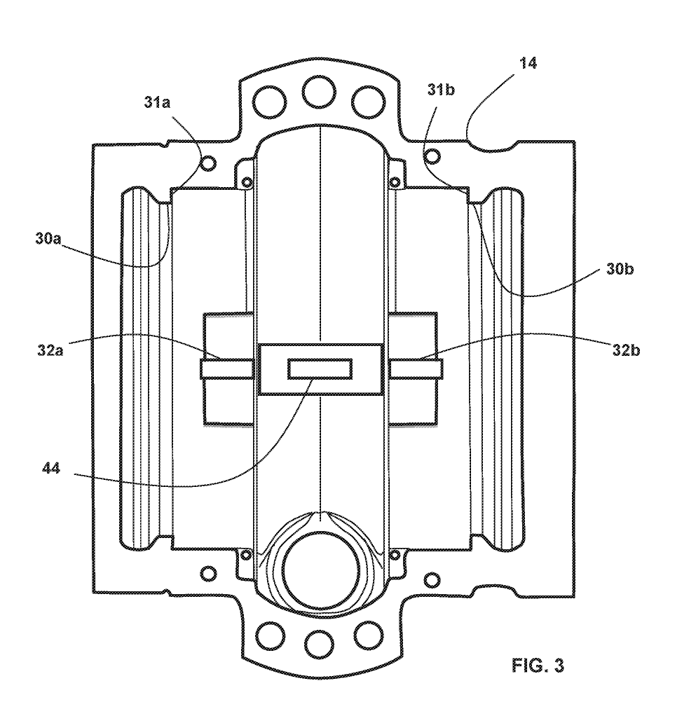

FIG. 3 shows a section of an inner casing 14 that has been adapted to receive exemplary modular inserts 20, 22, 24, wherein adaptations include key and/or slot arrangements to prevent rotation of the modular inserts 20, 22, 24 as well as protrusion/groove arrangements for sealing the seal carrier and blade carrier modular inserts 20, 24 against the inner casing 14 as a result of thermal expansion of the seal carrier and blade carrier modular inserts 20, 24.

In an exemplary embodiment shown in FIG. 2 and FIG. 3, the inner casing 14 and the seal carrier modular insert 20 includes a first slot 48 and a first key 32a configured to provide axial alignment and torque compensation so as to provide rotational restraints when connected to the inner casing 14. The first slot 48 and the first key 32a are complementarily arranged on the inner casing 14 and the seal carrier modular insert 20 such that, as shown in FIG. 2, the seal carrier modular insert 20 has a first slot 48 and the inner casing 14 has a first key 32a, or alternatively (not shown) the first slot 48 is configured on the inner casing 14 and the first key 32a is configured on the seal carrier modular insert 20.

In an exemplary embodiment shown in FIG. 2 and FIG. 3, the inner casing 14 and the inlet spiral insert 22 includes a second slot 44 and a second key 34 configured to provide axial alignment and torque compensation so as to provide rotational restraints when connected to the inner casing 14. The second slot 44 and the second key 34 are complementarily arranged on the inner casing 14 and the inlet spiral insert 22 such that, as shown in FIG. 2, the inlet spiral insert 22 has a second key 34 and the inner casing 14 has a second slot 44, or alternatively (not shown) a second slot 44 is configured on the inlet spiral insert 22 and the second key 34 is configured on the inner casing 14.

In an exemplary embodiment shown in FIG. 2 and FIG. 3, the inner casing 14 and the blade carrier modular insert 24 includes a third slot 46 and a third key 32b configured to provide axial alignment and torque compensation so as to provide rotational restraints when connected to the inner casing 14. The third slot 46 and the third key 32b are complementarily arranged on the inner casing 14 and the blade carrier modular insert 24, such that, as shown in FIG. 2, the blade carrier modular insert 24 has a third slot 46 and the inner casing 14 has a third key 32b, or alternatively (not shown) the third slot 46 is configured on the inner casing 14 and the third key 32b is configured on the blade carrier modular insert 24.

As shown in FIG. 2 and FIG. 3, the inner casing 14 includes a circumferential first radial protrusion 30a and the seal carrier modular insert 20 includes a circumferential first groove 40 configured to receive the first radial protrusion 30a.

The first radial protrusion 30a and the first groove 40 are complementarily configured so as to form a shrink ring and groove arrangement in which radial pressure resulting from thermal expansion of the seal carrier modular insert 20 is transferred to the inner casing 14 thereby forming a seal between the inner casing 14 and the seal carrier modular insert 20 in the axial and radial direction. To assist in the axial sealing, the first radial protrusion 30a may include an axial facing surface 31a facing in the direction of the inlet spiral insert 22 that seals against an axial facing sealing surface 41 of the seal carrier modular insert 20 as a result of axial force acting on the seal carrier modular insert 20 axially away from the inlet spiral insert 22.

As shown in FIG. 2 and FIG. 3, the inner casing 14 includes a circumferential second radial protrusion 30b and the blade carrier modular insert 24 includes a circumferential second groove 42 configured to receive the second radial protrusion 30b. The second radial protrusion 30b and the second groove 42 are complementarily configured so as to form a shrink ring and groove arrangement in which radial pressure resulting from thermal expansion of the blade carrier modular insert 24 is transferred to the inner casing 14 thereby forming a seal between the inner casing 14 and the blade carrier modular insert 24. To assist in the axial sealing, the second radial protrusion 30b may include an axial facing surface 31b facing in the direction of the inlet spiral insert 22 that is arranged to seal against an axial facing sealing surface 43 of the blade carrier modular insert 24 as a result of axial force acting on the blade carrier modular insert 24 in the downstream direction away from the inlet spiral insert 22.

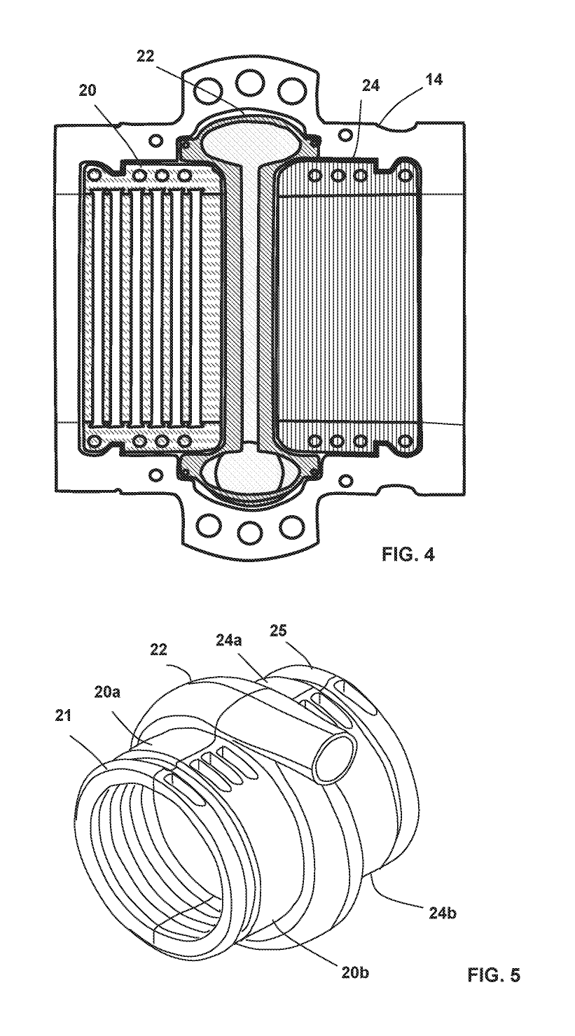

FIG. 4 shows modular inserts 20, 22, 24 inserted into a section of an inner casing 14, showing the interaction of grooves, protrusions and seal faces.

Although the disclosure has been herein shown and described in what is conceived to be the most practical exemplary embodiment, it will be appreciated that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather that the foregoing description and all changes that come within the meaning and range and equivalences thereof are intended to be embraced therein.

1. A steam turbine arrangement comprising:
an outer casing defining an outer limit of the steam turbine;
an inner case, encased by the outer casing, configured and arranged to form a steam expansion flow path in which work is generated by turbine stages located within the inner case;
a rotor, concentric to and contained at least partially within both the inner casing and the outer casing;
a seal carrier modular insert, towards a first end of the steam turbine, for carrying seals located between the inner casing the rotor, that is cylindrically shaped and removably insertable into the inner casing;
an inlet spiral insert, adjacent the seal carrier modular insert and removably insertable into the inner casing, for introducing steam into the steam expansion flow path so as to circumferentially distribute steam feed into the steam turbine; and
a blade carrier modular insert, adjacent the inlet spiral insert, that is cylindrically shaped and removably insertable into the inner casing, for retaining stationary blades.

2. The steam turbine of claim 1, wherein the inner casing and the seal carrier modular insert complementarily comprise a first slot and a first key configured to prevent rotation of the seal carrier module within the inner casing.

3. The steam turbine of claim 1, wherein the inner casing and the inlet spiral insert complementarily comprise a second slot and a second key configured to prevent rotation of the inlet spiral insert within the inner casing.

4. The steam turbine of claim 1, wherein the inner casing and the blade carrier modular insert complementarily comprise a third slot and a third key configured to prevent rotation of blade carrier modular insert within the inner casing.

5. The steam turbine of claim 1, wherein the inner casing comprises a circumferential first radial protrusion and the seal carrier modular insert comprises a circumferential first groove configured to receive the first protrusion,
wherein the first radial protrusion and the first groove are complementarily configured such that radial pressure resulting from thermal expansion of the seal carrier modular insert is transferred to the inner casing thereby forming a seal between the inner casing and the seal carrier modular insert.

6. The steam turbine of claim 1, wherein the inner casing comprises a circumferential second radial protrusion and the blade carrier modular insert comprises a circumferential second groove configured to receive the second protrusion,
wherein the second radial protrusion and the second groove are complementarily configured such that radial pressure resulting from thermal expansion of the blade carrier modular insert is transferred to the inner casing thereby forming a seal between the inner casing and the blade carrier modular insert.

7. The steam turbine of claim 1, wherein the seal carrier modular insert comprises two seal carrier halves split along a longitudinal axis of the seal carrier modular insert.

8. The steam turbine of claim 7, wherein the two seal carrier halves are joinable by bolted joints.

9. The steam turbine of claim 1, wherein the blade carrier modular insert comprises two blade carrier halves split along a longitudinal axis of the blade carrier modular insert.

10. The steam turbine of claim 9, wherein the two blade carrier halves are joinable by bolted joints.

11. The steam turbine of claim configured as a high pressure steam turbine.
